(19) United States
(12) Patent Application Publication
(10) Pub. No.: US 2006/0145130 A1
(43) Pub. Date: Jul. 6, 2006

(54) Wire and cable handling apparatus

(76) Inventor: Scott Giroux, White Lake, MI (US)

Correspondence Address: MCKELLAR IP LAW, PLLC, 784 SOUTH POSEYVILLE ROAD, MIDLAND, MI, 48640, US

(21) Appl. No.: 11/368,861

(22) Filed: Mar. 6, 2006

Related U.S. Application Data
(63) Continuation-in-part of application No. 11/143,376, filed on Jun. 2, 2005.
Application No. 11/143,376 is a division of application No. 10/408,714, filed on Apr. 7, 2003.

(51) Int. Cl. H02G 1/08

(52) U.S. Cl. 254/134.3 FT

(57) ABSTRACT

A wire and cable handling apparatus that is intended to provide the ability to draw long, and sometimes large, bundles of wire or cable while maintaining the safety of the user while providing an ergonomically correct pulling height and direction.

This application is a continuation-in-part of application Ser. No. 11,143,376, filed Jun. 2, 2005, now pending, which is a divisional application of U.S. original application Ser. No. 10/408,714, filed Apr. 7, 2003, now abandoned.

The invention disclosed and claimed herein deals with a wire and cable handling apparatus that is intended to provide the ability to draw long, and sometimes large, bundles of wire or cable while maintaining the safety of the user. The device of the invention provides an ergonomically correct pulling height and direction.

### BACKGROUND OF THE INVENTION

There are several prior art disclosures dealing with wire and cable guides and the like. For example, U.S. Pat. No. 2,272,721, which issued Dec. 20, 1955 to Pinkerton, describes a conductor wire guide that inserts into the interior of a wall mounted electrical box, that is used to pull wire from a conduit. The object of the device is to allow a vertical pull on the wire without having to move the wire over the edge of the conduit and damage the conduit.

U.S. Pat. No. 3,291,449, which issued on Dec. 13, 1966 to Hughes, deals with a cable puller that is a device that is situated over conduit such that the cable is pulled out of the conduit vertically. The cable is then directed right back down to the base of the device where it is wound around a take up drum. This device does not have any means with which to mount the device to stabilize it and furthermore, it would not seem to be necessary in view of the fact that the pull on the cable is not horizontal, or near horizontal, which would require such a stabilizing device.

In U.S. Pat. No. 4,033,551, that issued Jul. 5, 1977 to Lindstrom, there is disclosed a novel device that has the capability of pulling cable out of an underground cable conduit. The device is mount on the side of a house, and the cable is pulled vertically, and then directed downwardly to a take up pulley. This device does not have a base mount, and it is not deemed that it is necessary as the cable is directed downwardly, not horizontally.

U.S. Pat. No. 4,451,615 that issued on Sep. 17, 1985 to King deals with a guide roller for feeding electrical wire into conduit. The device consists of a bar roller that is affixed to the inside wall of an electrical wall box over which the wire is drawn.

In another device, Patterson, in U.S. Pat. No. 4,801,127 that issued Jan. 31, 1989 deals with a handle operated wire puller that is essentially a-frame that allows the wire to be drawn vertically and moved by the used of a draw handle mounted on the frame.

U.S. Pat. No. 6,340,271 that issued on Jan. 22, 2002 to Carlson, et al., dealw with a conduit cable feeding sheave. The invention deals with a pulley mounted in a yoke and attached to a sleeve. The sleeve is intended to fit down over an already existing conduit and be adjustable on such conduit.

Finally, the applicant is aware of U.S. Pat. No. 6,431,524, which issued on Aug. 13, 2002 to Weber in which a wire or cable pulling apparatus is disclosed. The apparatus is comprised of a combination of a standing upright pedestal and a base supporting the pedestal. However, the base is not configured to be mounted for stabilizing purposes and therefore does not provide the support that is characteristic of the device of the instant invention. Further, the device of Weber operates on a different principle than the device of the instant invention.

### THE INVENTION

The invention disclosed and claimed herein deals with a wire and cable handling apparatus that is intended to provide the ability to draw long, and sometimes large, bundles of wire or cable during construction.

With more specificity, the invention deals with a cable and wire handling apparatus comprising in combination a base member having a top surface, an enlarged center opening through it, and having at least two additional openings through it to receive bolts or other similar fasteners.

There is also a stanchion having a near end and a distal end wherein the stanchion is surmounted on the top surface of the base member at its distal end. There is a yoke mounted on the near end of the stanchion that has two parallel spaced-apart walls.

Each of the walls has a front edge and a top edge, wherein each wall has an opening through it located near the front edge and top edge of each wall, respectively, to receive a shaft between the walls.

There is a freewheeling pulley rotatably mounted on the shaft and the shaft has one or more devices for retaining the shaft in the openings.

### BRIEF DESCRIPTION OF THE DRAWINGS

FIG. 1 is a full, broken, side view of a device of this invention mounted on a concrete tower.

FIG. 2 is a full broken, front view of the device of this invention.

FIG. 3 is a view of the top part of a stanchion of this invention showing a detail of the yoke mounted on the stanchion.

FIG. 4 is a full bottom view of the base member of this invention showing the flat bottom.

FIG. 5 is a full front view of a device of this invention showing the centered hollow stanchion of this invention in place of the two-legged stanchion of FIG. 2.

### DETAILED DESCRIPTION OF THE INVENTION

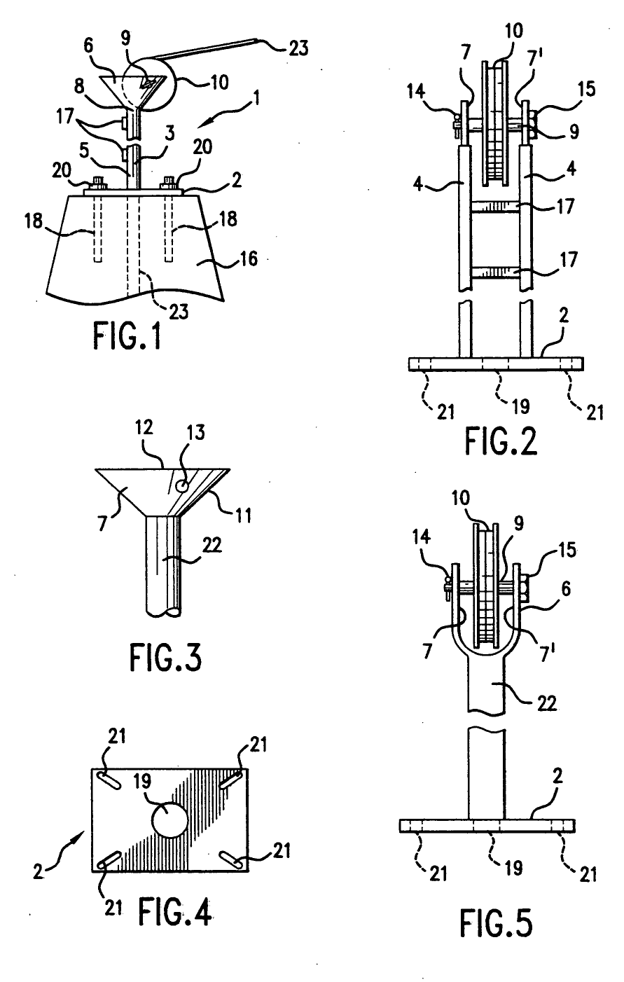

Turning now to the Figures, and with reference to FIGS. 1 and 2, there is shown a cable and wire handling apparatus 1, preferably manufactured from metal, that is a combination of a base member 2, a stanchion 3 mounted vertically on the base member 2, said stanchion 3 having a distal end 5 (in FIG. 1, the bottom end) and a near end 8 (in FIG. 1, the top end), the stanchion 3 preferably comprising two legs 4 (see FIG. 2), that are preferably fixedly attached to the base member 2 at the bottom end 5. Also shown are a yoke 6, comprised to two walls 7 and 7′, that are fixedly attached to the top end 8 of the stanchion 3. Also shown is the cable or wire 23 that is also shown in phantom in the concrete tower 16, leading into the common channel or conduit (not shown) below the concrete tower 16.

Supported in the yoke 6 is a shaft 9, upon which is situated a pulley 10. The pulley 10 is rotatably mounted on the shaft 9 such that is free-wheeling. The shaft 9 is supported by its insertion in two openings 13 and 13′ (see FIG. 3, wherein 13′ is not shown) in the yoke 6, near the front edge 11 and the top edge 12, of each wall 7 and 7′.

The shaft 9 is retained in the openings 13 and 13′ by a device 14 such as a cotter pin, or the like. The shaft 9 can be rotatable or can be fixed with the pulley 10 rotating about the shaft 9. Further, as shown, the shaft 9 is, but it is not so limited, to a round bolt, that has a hexagonal head 15 (FIG. 2), with the opposite end of the shaft 9 having the cotter pin through an opening (not shown) through the shaft. It is within the scope of this invention to provide a shaft 9 that is threaded on one end such that a nut can be used to hold the shaft 9 in place, yet allow the shaft 9 to freely rotate about the shaft 9, if desired.

Shown as 17 is a brace that connects from legs 4 for support and stabilization of the stanchion 3 (there are two such braces 17 shown in FIG. 2). The number of braces 17 is not critical and there can any reasonable number, or the brace 17 can be a full or partial back panel. As noted, the legs 4 are straight to allow for the resistance to stress placed on the stanchion 3 by the pulling of wire and cable.

The length of the legs 4 or the center hollow post 22 (FIG. 5) is dependent on the type of cable or wire that needs to be pulled therethrough. It is desired that the stanchion 3 be at the level of about a man's waist to mid-chest in height, that is, about 36 to 54 inches from the ground, or outlet that the cable or wire is being pulled from, in that, such a height is the most desirable to enable one to manually pull on the cable or wire to move it over the pulley 10 and from the outlet without injury to the back and legs and is ergonomically, the safest. Thus, the device of this invention has a nominal height of about 6 inches to about 24 inches in order to accommodate the height of the cement towers on which they are used and to accomplish the ergonomic effect alluded to just Supra.

In FIG. 1, the apparatus 1 is shown mounted on a concrete tower 16, much like the towers that support electrical poles in a parking lot lighting scheme. As shown in FIG. 1, the base member 2 is affixed to the concrete tower 16, and as shown in FIG. 1, this is accomplished by the use of bolts 18 (shown in phantom in FIG. 1) that are embedded in the concrete tower 16, generally as the concrete tower 16 is fabricated. The apparatus 1 is situated on the concrete tower 16 by placing the base member 2 down over the bolts 18, and then the base member 2, and hence the apparatus 1 of this invention, is secured to the concrete tower 16 using fastening devices 20 such as in this case, nuts that are screwed onto the bolts 18 to prevent movement of the apparatus 1 when in use. The openings 21 (FIG. 4) are used to allow the base member 2 to be placed down on the concrete tower 16, as the bolts 18 pass through openings 21. The bottom of the base member 2 has to be flat in order to sit correctly on the concrete tower without interference from other components of the device in order to stabilize the device correctly.

The base member 2 should have at least two such openings 21, and it is better to have three or more such openings 21. Most preferred, is four or more such openings 21 with the understanding that the openings 21 may be circular, or most preferred, they should be oval or elongated such that it is easy to position the base member 2 thereupon.

The base member 2 is shown in FIG. 4, which is a full bottom view of the base member 2 showing the center opening 19, the securing openings 21 and the flat bottom. The center opening 19 can have any configuration such as round, square, elongated, rectangular, but most preferred is a circular opening, in which the edges of the opening are slightly rounded or beveled such that they will allow the movement of cable or wire over them without excessive abrasion or tearing.

FIG. 5 is a full, broken frontal view of an apparatus of this invention wherein the stanchion 3 is a single hollow post.

In use, the workman places the apparatus 1 on the concrete tower 16, inserts a guide and draw wire through the center opening 19, and on into the common channel or conduit and until it is possible to attach the draw/guide wire to the wire or cable to be pulled through the conduit, and then the guide wire is looped over the pulley 10, and the wire, and eventually the desired cable or wire is pulled by hand (manually), or is hooked to an iron horse or other mechanical pulling device, and the cable or wire is pulled to the top of the stanchion 3. Any other cable or wire that is desired to be pulled to the same outlet is then pulled. Thereafter, the apparatus 1 is removed and is moved to the next concrete tower that is to be electrified.

It should be understood by those skilled in the art that the apparatus of this invention should essentially be manufactured from metal. It is especially useful to provide a strong metal such as steel or cast iron for the base member 2, the stanchion 3, and the yoke 6. Further, the stanchion 3 is vertical in order to withstand the stresses from pulling the cable or wire. The pulley 10, shaft 9, and fastening devices may be manufactured from lighter metals such as aluminum and the like, but it is preferred that the entire device be manufactured from a stronger metal as indicated just supra.

The device of this invention has the advantage that it is capable of being substantially fixed to the concrete tower or other support for the electrical equipment in a vertical position and is therefore not moveable under stress of use, and allows the smooth movement of the desired cable or wire to the outside of the concrete tower or similar outlet. In addition, the apparatus of this invention is ergonomically correct in terms of pulling the cable or wire without undue stress on the person pulling the cable in view of the fact that the pulley is up at the level that allows a straight pull on the cable or wire without having to bend over, or pull upwardly. Furthermore, the device of this invention allows the smooth movement and enhanced movement of the cable or wire owing to the fact that the centered opening in the base member, along with the freewheeling pulley allows for a reduction in friction that is associated with pulling many feet of such cable or wire. Such a configuration allows one to use the device of this invention by using a motorized vehicle or iron mule to pull cable and wire, without the device falling or moving.

What is claimed is:

1. A cable and wire handling apparatus comprising in combination:
(i) a base member having a top surface, a flat bottom surface, an enlarged center opening therethrough, and at least two additional openings therethrough;
(ii) a vertical stanchion having a near end and a distal end, said stanchion having at least two legs and surmounted on the top surface of said base member at the distal end thereof;
(iii) a yoke having two parallel spaced-apart walls, said yoke being surmounted on the near end of said stanchion, each said wall having a front edge and a top edge, wherein each said wall has an opening therethrough located near the front edge and top edge thereof of each wall, respectively, to receive a shaft between the walls;
(iv) a free-wheeling pulley rotatably mounted on said shaft;
(v) one or more devices for retaining said shaft in said openings.

2. An apparatus as claimed in claim 1 wherein the stanchion has support members to support and stabilize the legs.

3. An apparatus as claimed in claim 1 wherein the base member has two openings therethrough.

4. An apparatus as claimed in claim 1 wherein the base member has three openings.

5. An apparatus as claimed in claim 1 wherein the base member has more than three openings.

6. An apparatus as claimed in claim 1 wherein the stanchion is fixedly attached to the base member.

7. An apparatus as claimed in claim 1 wherein the pulley is mounted over the centered opening of the base.
